(19) United States
(12) Patent Application Publication
(10) Pub. No.: US 2003/0170524 A1
(43) Pub. Date: Sep. 11, 2003

(54) Direct methanol cell with circulating electrolyte

(76) Inventors: Karl Kordesch, Graz (AT); Viktor Hacker, Graz (AT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/336,684

(22) Filed: Jan. 6, 2003

Related U.S. Application Data
(63) Continuation of application No. 10/152,068, filed on May 22, 2002.
Application No. 10/152,068 is a continuation of application No. PCT/CA00/01376, filed on Nov. 23, 2000.

(30) Foreign Application Priority Data
Nov. 23, 1999 (CA) 2,290,302

(51) Int. Cl. H01M 8/02; H01M 2/38; H01M 4/90; H01M 4/96; H01M 4/92

(52) U.S. Cl. 429/34; 429/81; 429/40; 429/44; 429/42

(57) ABSTRACT

A fuel cell includes a circulating electrolyte for preventing fuel cross over. The electrolyte is past through a porous spacer positioned between the anode and the cathode. The circulating electrolyte removes any unused methanol fuel from the cell. The methanol may then be reclaimed from the electrolyte in a distillation loop.

### BACKGROUND OF THE INVENTION

1. Field of the Invention

The present invention relates to fuel cell systems and, more particularly, to fuel cell systems having reduced reactant cross-over.

2. Description of the Prior Art

Due to the increasing demands for inexpensive, efficient and non-polluting energy sources, various alternatives have been pursued. One of such alternative energy sources is the electrochemical fuel cell. Such fuel cells convert a generally commonly available fuel and an oxidant to electricity leaving relatively safe by-products. A typical fuel cell includes, in addition two the fuel and oxidant, to generally planar electrodes (an anode and a cathode), and an electrolyte. Generally, the electrolyte is provided between the cathode and the anode. The electrodes are normally formed of a porous substrate that allows the fuel and oxidant to diffuse through and are usually covered on opposing surfaces with a catalyst for the respective reduction and oxidation (redox) reactions.

The redox reactions result in the production of protons and electrons at the anode. The electrodes are electrically connected, through an external load, so as to provide a path for the electrons generated by the redox reactions. To accommodate the flow of protons from the anode to the cathode, the cells are normally provided with an ion, or more specifically, a proton exchange membrane between the electrodes.

In use, the fuel is passed through the porous anode substrate until it contacts the oxidation catalyst layer where it is oxidized. At the cathode, the oxidant diffuses through the porous cathode substrate and is reduced at the reduction catalyst layer. The fuels and oxidants for these cells are provided in a fluid state and consist of gases or liquids. Examples of fuels that can be used in fuel cells are hydrogen and lower alcohols such as methanol. The oxidant is usually oxygen that can be supplied either as pure oxygen or as air.

In the case of a hydrogen fuel cell, the fuel, hydrogen, is provided in a gaseous state and the following reactions take place:

| | |
|---|---|
| Anode: | H₂ → 2H⁺ + 2e⁻ |
| Cathode: | ½O₂ + 2H⁺ + 2e⁻ → H₂O |

As mentioned previously, the above oxidation reaction at the anode results in the production of protons and electrons. The electrons and conducted from the anode to the cathode by means of an electrical connection. The protons migrate from the anode to the cathode through the proton exchange membrane to react with the oxygen to form water.

Fuel cells can be categorized as “indirect” or “direct”. In the case of indirect fuel cells, the fuel, usually a lower alcohol, is first processed, or reformed, before it is introduced into the cell. With direct fuel cells, the fuel is not pre-processed, thereby simplifying system.

In the case of a direct methanol fuel cell, the following reactions occur:

| | |
|---|---|
| Anode: | CH₃OH + H₂O → 6H⁺ + CO₂ + 6e⁻ |
| Cathode: | 1½O₂ + 6H⁺ + 6e⁻ → 3H₂O |

For the direct methanol fuel cell, the flow of protons and electrons are the same as that for the hydrogen fuel cell discussed above. The methanol fuel is provided in a either a liquid or vapour state. It is known that other types of fuels may be utilized in such direct fuel cells. Such fuels may include, by way of example, other simple alcohols, such as ethanol, dimethoxymethane, trimethoxymethane, and formic acid. Further, the oxidant may be provided in the form of an organic fluid having a high oxygen concentration or hydrogen peroxide solution, for example. Such direct methanol fuel cells are taught in following U.S. Pat. Nos. 5,672,439; 5,874,182; and, 5,958,616.

The electrolyte used in fuel cells may be either liquid or solid. In the case of a solid electrolyte, the proton exchange membrane may also serve as a polymer electrolyte membrane (PEM), thereby providing two functions. As taught in U.S. Pat. No. 5,958,616, such PEM's may comprise a hydrated sheet of a perfluorinated ion exchange membrane such as a polyperfluorosulfonic acid membrane, sold under the tradename NAFION® (E.I. du Pont de Nemours and Co.).

In any of the fuel cells mentioned above, it is important to maintain a separation between the anode and the cathode so as to prevent fuel from directly contacting the cathode and oxidizing thereon. For this reason, the proton exchange membrane must also function as a separator for the fuel and oxidant. However, the known membranes, although functioning well as proton exchangers and/or solid electrolytes, are not very efficient as fuel separators and a common problem in fuel cells is the incidence of fuel cross over, which occurs when the fuel, prior to oxidation, diffuses through the membrane and contacts the cathode. Apart from the parasitic loss of fuel and oxidant from the system, such cross over results in a short circuit in the cell since the electrons resulting from the oxidation reaction do not follow the current path between the electrodes. Further, other disadvantages of fuel cross over may include structural changes on the cathode surface (i.e. sintering etc.) and poisoning of the reduction catalyst by fuel oxidation products.

One method of addressing this issue is to decrease the porosity of the membrane thereby preventing any fuel from crossing over. However, with this solution, the flow of proton will also be impeded, thereby resulting in decreased conductivity of the cell and, therefore, lower performance. As known in the art, fuel cell performance is defined as the voltage output from the cell at a given current density (or vice versa); thus, the higher the voltage at a given current density or the higher the current density at a given voltage, the better the performance.

The above mentioned U.S. patents provide various solutions to the problem of fuel cross over in fuel cells. In each case, the solution provided lies in improvements to the PEM. For example, U.S. Pat. Nos. 5,672,439 and 5,874,182 teach novel PEM's having essentially a laminated structure wherein the PEM is provided with one or more layers of an oxidation catalyst for oxidizing any fuel that may diffuse through. U.S. Pat. No. 5,958,616 provides a PEM having a plurality of voids for sequestering any fuel that may be passing there-through. However, such membranes are more expensive thereby adding to the cost of the cell.

Another problem associated with PEM containing cells is that the membrane must be maintained in a hydrated state in order to function as a proton exchanger and as an electrolyte. This requires, therefore, a separate hydration system to ensure that the membrane does not dry out.

Thus, there exists a need for an improved fuel cell system that overcomes the above mentioned problem of fuel cross over as well as other deficiencies in the known systems.

### SUMMARY OF THE INVENTION

### BRIEF DESCRIPTION OF THE DRAWINGS

These and other features of the preferred embodiments of the invention will become more apparent in the following detailed description in which reference is made to the appended drawings wherein:

FIG. 1 is an exploded side cross sectional views of a direct methanol fuel cell according to one embodiment of the invention.

FIGS. 2 to 6 are side cross sectional views of a direct methanol fuel cell according to other embodiments of the invention.

FIG. 7 is a schematic illustration of a direct methanol fuel cell system according to one embodiment of the invention.

FIG. 8 is a graph illustrating the Open Current Voltage (OCV) of a fuel cell while in operation.

### DESCRIPTION OF THE PREFERRED EMBODIMENTS

In general terms, the present invention provides a fuel cell wherein any un-reacted fuel is purged from the system so as to reduce or eliminate any fuel cross over. As used herein, the term “fuel cross over” is intended to mean the un-desired flow of un-reacted fuel from the anode to the cathode.

In a preferred embodiment, the invention provides a fuel cell having a circulating electrolyte that flows between the electrodes (the anode and the cathode) of the cell and which serves to remove any un-oxidized fuel that diffuses through the anode. In this manner, un-reacted fuel is removed from the fuel cell before it reaches the cathode, thereby avoiding fuel cross over.

In one embodiment, the fuel cell of the invention allows any un-reacted fuel to be recycled back to the cell.

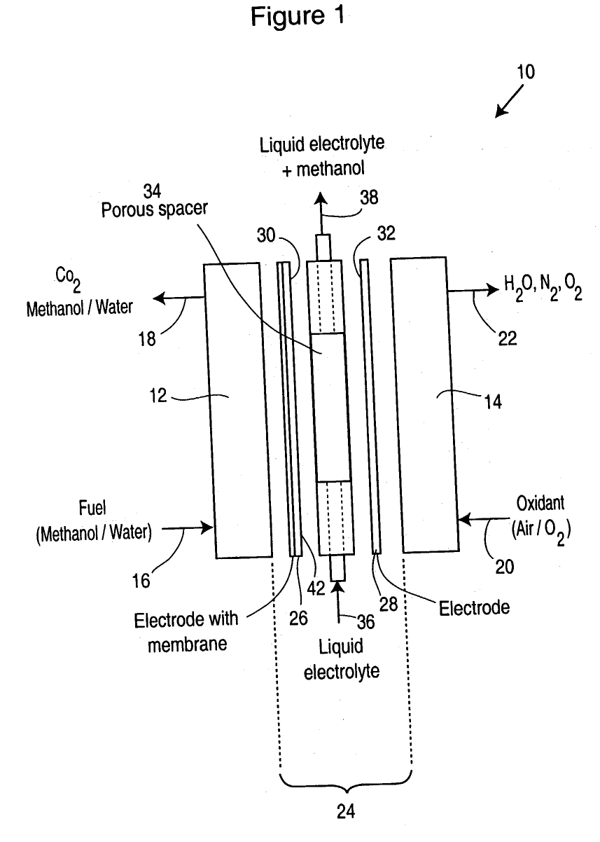

A direct methanol fuel cell according to one aspect of the invention is illustrated in FIG. 1. As shown, the fuel cell 10 essentially consists of a planar “sandwich” having, as its outer surfaces, two end plates 12 and 14. The end plates may be formed as commonly known and may comprise materials such as polysulphon or other materials as will be known to persons skilled in the art. First end plate 12 is provided with a fuel inlet 16 and an outlet 18 for releasing un-reacted fuel and reaction products. Similarly, second end plate 14 is provided with an oxidant inlet 20 and an outlet 22 for un-reacted oxidant and reaction products. The space between plates 12 and 14 essentially comprises the reaction chamber 24 of the fuel cell.

The reaction chamber 24 includes a pair of generally porous electrodes comprising an anode 26 and a cathode 28 having opposing surfaces 30 and 32, respectively. The electrodes generally comprise sheets that are parallel to the plates 12 and 14. The electrodes may be made in any conventionally known manner and are formed of a porous material so as to allow the reactants to pass through. For example, electrodes for the present invention may be formed from a base of carbon cloth, or carbon fibre paper, having sprayed thereon, NAFION® and/or E-TEK. Other electrode materials will be apparent to persons skilled in the art. For example, various porous carbon materials have been used to form electrodes for phosphoric acid fuel cells and such electrodes can be used, for example, in direct methanol fuel cells as well. Typically, the porous carbon electrodes are polytetrafluroethylene (PTFE) bonded and have carbon sheets or carbon fleece as a base structure. Corrosion resistant stainless steel foams can also be used as an the base structure.

Although not shown in FIG. 1, the electrodes are electrically connected as known in the art to conduct the flow of electrons generated in the cell.

Each of the opposing surfaces 30 and 32 of the electrodes are provided with a thin catalyst layer (not shown) for catalyzing the oxidation and reduction reactions of the cell. The catalysts that are used in the invention may be any of those commonly known such as platinum (Pt), or a Pt and Ruthenium (Ru) combination. Various other catalysts for the fuel cell, such as carbon black, other noble metals etc., will be apparent to persons skilled in the art.

In the embodiment shown in FIG. 1, the surface 30 of the anode 26 is provided with a proton exchange membrane 40. The membrane 40 preferably comprises a polymer electrolyte membrane (PEM) as described above. In the preferred embodiment, the polymer electrolyte is acidic so as to act as an efficient hydrogen ion conductor and also to neutralize any CO₂ produced during the course of the reaction. In other embodiments, the membrane may be of any other commonly known material such as Gore-Tex® etc.

A medium 34 is provided between the electrodes 26 and 28, through which an electrolyte is flowed. In one embodiment, as shown in FIG. 1, the medium 34 comprises a porous spacer material positioned between the electrodes. The medium includes an electrolyte inlet 36 and an outlet 38 for the electrolyte and any reaction components entrained therein. The electrolyte used in the preferred embodiment is an acidic solution and more preferably, comprises a solution of sulphuric acid.

In operation, the fuel is provided to the cell 10 via anode inlet 16 and, after the oxidation reaction, the resulting products and any un-reacted fuel is expelled from the system through outlet 18. Similarly, the oxidant for the reaction is introduced through cathode inlet 20 and the products from the reduction reaction are expelled through cathode outlet 22. The fuel diffuses through the porous anode 26 and is oxidized at the catalyst layer contained on anode surface 30. A proton exchange membrane 42 provided on surface 30 aids in conducting the protons towards the cathode. An electrical connection (not shown) conducts the electrons from the anode towards the cathode and through an external load. However, along with the protons generated by the oxidation reaction, a portion of any un-reacted fuel, and a portion of the reaction products may pass through the anode 26 and the membrane 42 and enter the medium 34 containing a fluid electrolyte stream (not shown). The electrolyte enters the medium via inlet 36 and exits at outlet 38. In passing through the medium 34, the electrolyte entrains any un-reacted fuel as well as any reaction products, such as CO₂. In this manner, the electrolyte stream contained in medium 34 removes any potentially damaging products and reactants from the fuel cell system thereby maintaining the performance of the cell. However, being acidic, the fluid electrolyte does not impede the flow of protons between the anode and the cathode.

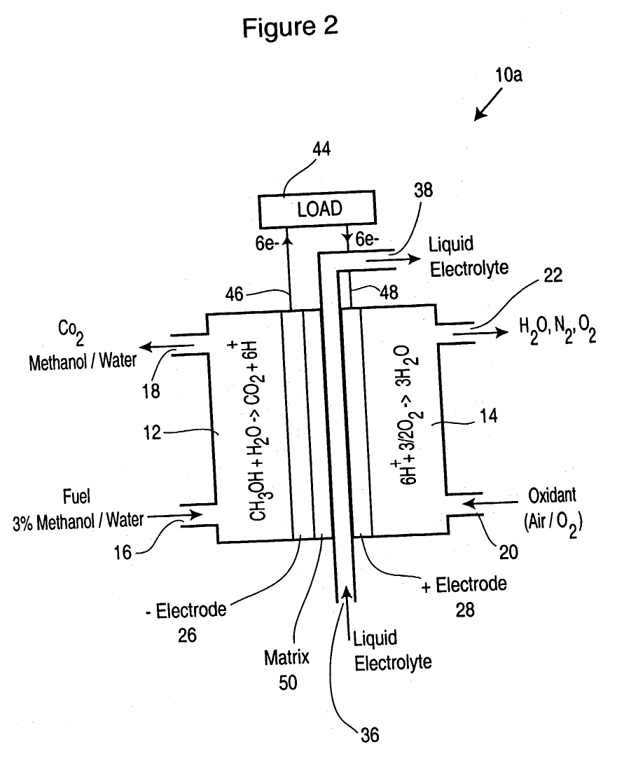

FIG. 2 illustrates another embodiment of the invention and shows the cell of FIG. 1 in an assembled state and wherein like numerals are used to identify like elements. In the cell 10a FIG. 2, the fluid electrolyte is not flowed through a medium but consists solely of an electrolyte stream. However, such cell functions is the same manner as the cell of FIG. 1. FIG. 2 also more clearly illustrates the electrical connection between the electrodes 26 and 28. Specifically, the anode 26 is connected to an external load 44 by means of a first conductor 46. Similarly, the load 44 is connected to the cathode 28 by a second conductor 48. FIG. 2 also illustrates the use of a commonly known matrix 50 instead of an electrolyte membrane as in FIG. 1.

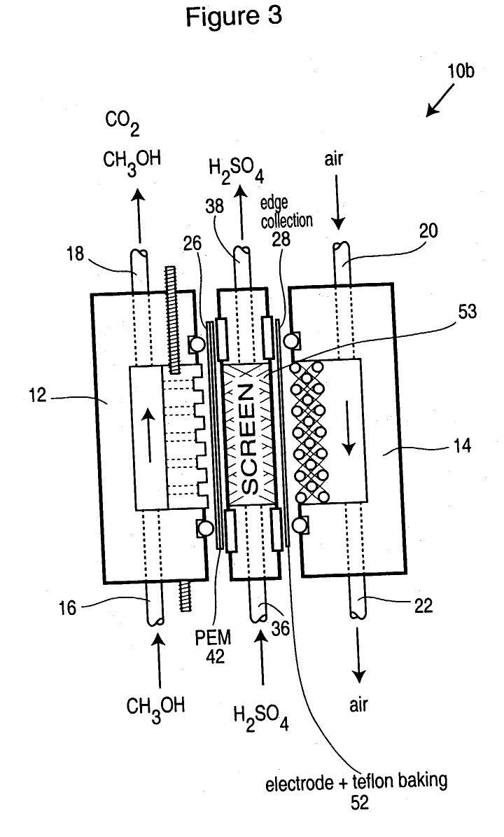

FIG. 3 illustrates yet another embodiment of the fuel cell of the invention, wherein elements common with FIG. 1 are identified with like numerals. In the cell 10b of FIG. 3, the anode 26 is provided with a PEM 42 as in FIG. 1. However, in this case, the cathode 28 is also provided with a coating 52 comprising a Teflon® material. As illustrated, the cell 10b of FIG. 3 includes a counter-current flow of oxidant with respect to fuel. The acid electrolyte follows the same direction as that of the fuel. The embodiment shown in FIG. 3 also illustrates the use of a screen mesh 53 as the fluid electrolyte medium instead of the porous spacer 34 of FIG. 1.

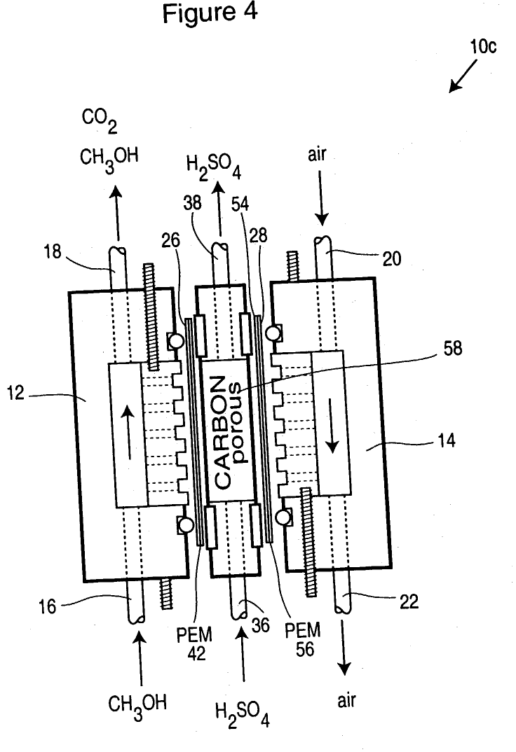

FIG. 4 illustrates yet another embodiment of the fuel cell of the invention. In this case, the cell 10c is of a similar structure as that of FIG. 3. As in FIG. 1, the anode surface 30 is provided with a PEM. However, in this case, the cathode surface 54 facing the anode 26 is also provided with a PEM 56. As also illustrated in FIG. 4, the medium through which the fluid electrolyte is passed comprises porous carbon material 58.

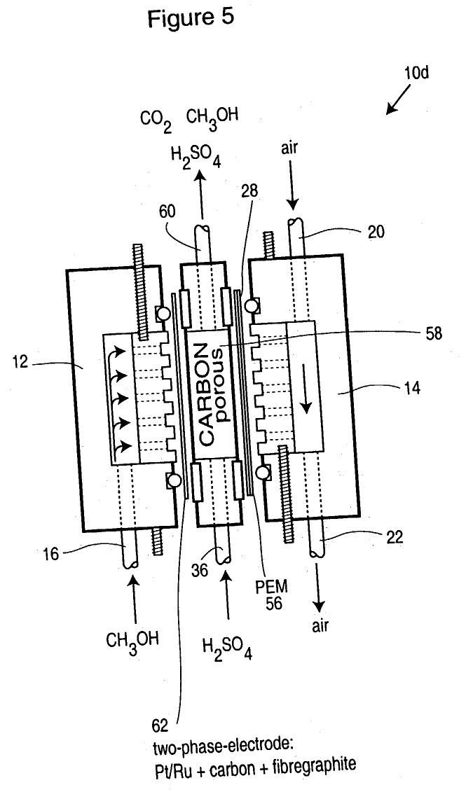

FIG. 5 illustrates another embodiment of the invention wherein the cell 10d is generally of the same structure as that of FIG. 4. However, in this case, the plate 12 of the anode side of the cell is not provided with outlet for the oxidation reaction products. Instead, such products, including and un-reacted fuel, is diverted to the fluid electrolyte stream and exits at a common outlet 60. Further the anode 62 of the cell of FIG. 5 comprises a two-phase electrode made of a porous carbon base and including fibre graphite and a Pt/Ru catalyst. As with FIG. 4, the cathode is provided with a PEM 56.

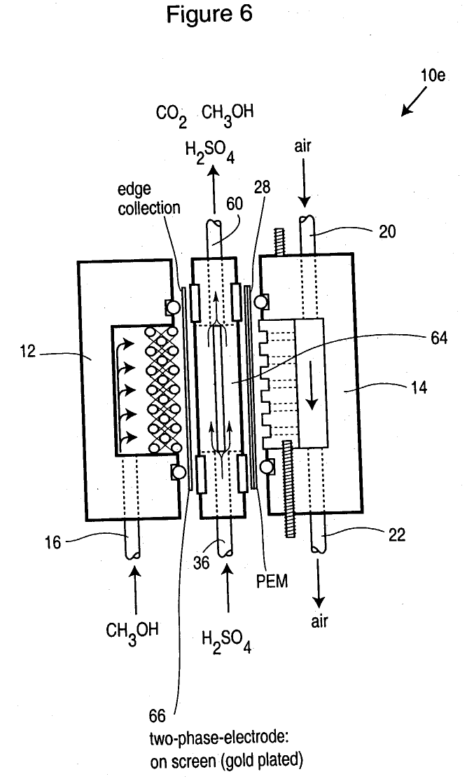

FIG. 6 illustrates yet another embodiment wherein the cell 10e comprises generally the cell of FIG. 5 with some modifications. Firstly, the cell 10e is provided with a fluid electrolyte medium that comprises a dual channel conduit 64, which serves to reduce fuel cross over in two consecutive stages. Further, the anode 66 comprises another two phase structure comprising a gold plated screen with the desired catalyst.

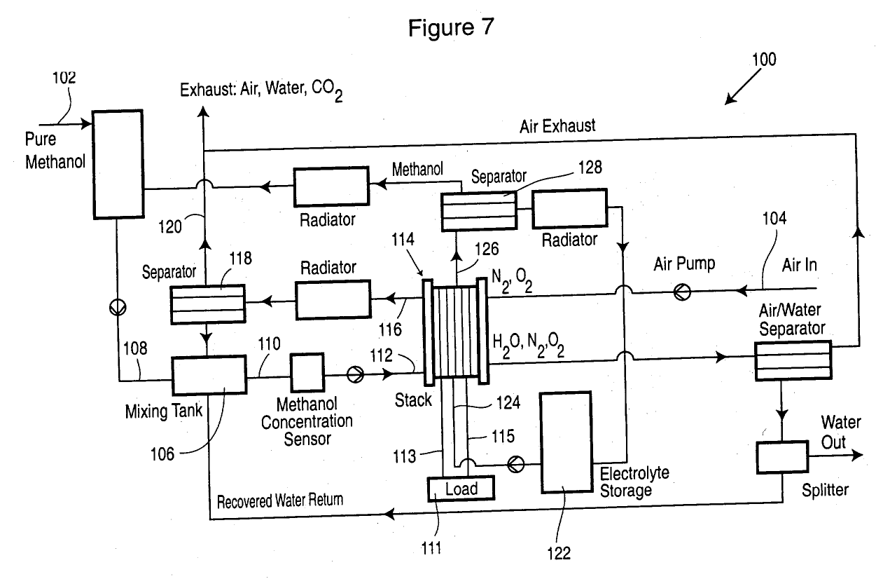

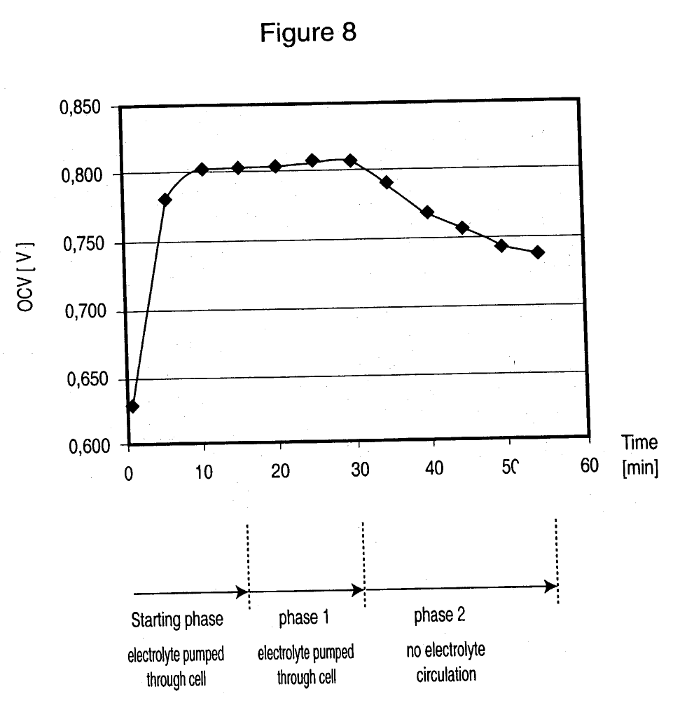

FIG. 7 illustrates a schematic representation of the process of the invention. As can be seen, fresh fuel, which, in the embodiment illustrated is methanol, is provided to the system 100 at inlet 102. Fresh oxidant, such as air, is provided to the system at inlet 104. The fuel is passed to a mixing tank 106, which will be discussed later, through an inlet 108. The outlet 110 of the mixing tank is fed to an inlet 112 of the cell 114. The cell 114 includes an outlet 116 for expelling the reaction products from the oxidation reaction. Such products are fed into a separator 118, which separates out any un-reacted fuel and diverts same to the mixing tank 106 where it is mixed with freshly supplied fuel. A vent 120 provided on the separator 118 expels any reaction products (i.e. air, water, CO₂) from the system.

In the cell, which is of any of the designs mentioned above, the fuel is oxidized to produce a proton and electron stream. The proton stream is diverted to the cathode where the reduction reaction takes place. The electrons generated in the oxidation reaction are conducted from the anode to the cathode through an external load 111 via conductors 113 and 115. As discussed above, the invention provides the fuel cell with a circulating electrolyte to prevent any fuel cross over. As illustrated in FIG. 7, the electrolyte is provided from a storage tank 122 and is fed into the cell via inlet 124. The flowing electrolyte collects any un-reacted fuel and other reaction products and exits the cell through outlet 126. The electrolyte stream is then fed to a separator 128, which separates the electrolyte from the reaction products and supplies re-generated electrolyte back to the storage tank 122. The separator also regenerates un-reacted fuel and returns same to the fresh fuel inlet stream.

Apart from above mentioned advantages, further advantages of the present invention include: improved cell heat dissipation; hydration of the PEM; removal of unwanted reaction products (e.g. CO2). Further with the invention, any lost catalyst may also be recovered.

### EXAMPLES

The following examples are used to illustrate the present invention and should not be considered to limit same in any way.

1. Manufacture of PEM:

For our investigations we used NAFION plus E-TEK electrodes (Single sided ELAT electrode 4 mg/cm² Pt/Ru). Form the literature you get a very good idea of how to make own electrodes and how to prepare them properly. The base material often is a carbon cloth (35 mm)[10] with Vulcan XC72 (30% PTFE, 20-30 μm) on both sides. As catalyst (30-40% PTFE) 20% Pt on Vulcan XC 72 diluted with XC72 is used. At the end NAFION solution is sprayed on the surface (M=1100 kg/kmol, ˜50 A, 0-2,7 mg/cm² dry weight) which should diffuse for 10 min and dry for app. 2 h at 80° C.

One major point concerns the preparation of NAFION. Before NAFION can be used several steps of preparation have been done namely boiling in

3% H2O2

deionised water

0.5 M H2SO4

deionised water for over one hour each [10]. Afterwards the NAFION membranes have to be pre-dried (45 min. on a 60° C. heated vacuum table. Then the catalyst layer has to be hot pressed onto the membrane at 125° C. and 105 atm for 120s [9] (140° C. for 3 minutes [1]). The assembly has to be sandwiched between two uncatalysed carbon-cloth gas-diffusion backings (E-TEK). The parameters for pressing are

temperature of app.140° C.

pressure of app.1000 kg/cm²

for 3 min

2. Electrodes

The used electrodes have been ordered by E-TEK. The EFCG electrode on TGPH-120 Toray Carbon Paper has a loading of 4 mg/cm² Pt/Ru. The ordered area is 23*23 cm.

3. Test Results

The first built system ran with hydrogen and oxygen using a 0.5 M H2SO4 electrolyte between the anode and cathode. We did not heat the system up, so the temperature was app. 20° C. Graph 1 shows the recorded voltage/current-density curve. Because of our limited test equipment we were only able to go up to 2.5 A which corresponds to 550 mA/cm². This system works fine and provides 550 mA/cm² @ 0.35 V.

[image]

Graph 1: Voltage/Current Density Curve with Hydrogen and Oxygen at 20° C. without Pressure and 0.5 M H2SO4 as Electrolyte.

The next step was to record U-I curves with the same system setup but air instead of pure oxygen. Graph 2 shows the graph and we reached only 300 mA/cm² @ 0.1 V. The assumption is that a system running with air instead of pure oxygen has to be made pressurized.

[image]

Graph 2: Voltage/Current Density Curve with Hydrogen and Air at 20° C. and Pressure Less

In order to have best conditions for first tests with methanol pure oxygen was used again. The system setup stays the same, but a new feeding system for methanol as fuel and for the circulating electrolyte has been introduced.

The first experiments did not lead to any promising results because there was a leakage problem at the anode side. The first used material (kind of neoprene) was to porous. So a special sealing gel (from the automotive sector) which is resistant again water alcohol solutions and high temperatures has been used. The good thing is that it remains plastic and therefore the cell can be opened again without any efforts. In order to avoid contact problems the O-ring sealing at the anode and cathode have been removed and this special sealing gel has been used. This arrangement makes also sure that there is enough contact between the electrode and the carbon contact plate.

I measured the OCV which lied between 0.7 and 0.8. The recording of U-I curves failures because the cell voltage broke down under load.

The next step was to keep this system but to increase the temperature to 50,60, 90° C. The results became better, always making first tests with a little fan. The problem is that it still was not possible to record curves because the voltage falls very rapidly under load (even when measuring resistance-free). Because of the boiling point at 64° C. of methanol I stayed at a temperature of 60° C.

The change of the molarity of the electrolyte was the next step. So mixtures of 0.5, 1, 5 and 10 M H2SO4 have been tried out. The improvement was very little so the conclusion was that this influence is negligible.

Mixtures of 1, 2, 5 and 10 M MeOH I even put in pure methanol but I did not get improvements.

Because we are circulating the electrolyte it is possible to run with higher methanol concentrations.

The next step was to build a vapor feed system. We thought that the problem could be that no methanol comes to the fine pores when putting a load on the cell because those electrodes are gas diffusion electrodes. The temperature in the test rig was >90° C. We also did not get results because the OCV only reached app. 0.35 V and the cell did not even manage to power the fan.

All those experiments have been made without pressure and so the next step will be to build a system where the pressure can be changed.

Although the invention has been described with reference to certain specific embodiments, various modifications thereof will be apparent to those skilled in the art without departing from the spirit and scope of the invention as outlined in the claims appended hereto.

As described above, the present invention provides a fuel cell system for the electrochemical production of electricity from liquid and gaseous fuels on the anodic side and oxygen and air on the cathodic side, whereby the electrode reactions are happening in catalyst regions (interfaces) contained in porous electrodes and the reaction products are continuously removed in circulating gas streams which also provide new gas supply and in a circulating electrolyte which serves also as a heat managing liquid stream, thereby characterized, that the speed of electrolyte circulation determines the build-up of the fuel or reactant cross-over gradient in the cell and the removed methanol is reclaimed in a distillation loop.

In the fuel cell system of the invention, separators or matrix may be attached to the electrodes to reduce the methanol outflow (at the anode) or minimize the reaction of the methanol on the air-cathode. Further, one of the separators (on the anode) can be of the PE-Membrane type. The matrix or separator barriers may be chosen from microporous materials like asbestos.

In the fuel cell system of the invention, the circulating electrolyte is a good conductive salt solution selected from the group of battery electrolytes with a pH of neutral to low acidic values. Examples of such electrolytes include KSCN or NH₄SCN, acidified K₂SO₄, or selected strong organic acids (Superacids).

With fuel cell systems according to one embodiment of the invention, the temperature of the cell is high enough to allow a methanol distillation recovery loop) (over 70 deg.C.).

Further, the fuel feed can be as an aqueous solution of methanol or as methanol vapour. The fuel feed can be such that the concentration of the methanol (% in water or methanol gas vapor pressure) can be increased to give a higher anode voltage simultaneous with the adjustment of the methanol barriers and the speed of electrolyte circulation which reduce the crossover which will then tend to increase.

With fuel cell systems according to one embodiment, the electrodes can be porous all-carbon electrodes (the baked carbon type) in tubular or plate shape, carrying the proper catalysts for the anode and cathode reactions. Further, the electrodes can be of the type used for PAFC systems, sprayed or layered PTFE bonded porous carbon layers on a woven carbon (graphite) sheet or carbon fleece or carbon fiber carrier. The electrodes can be stainless steel screen supported plate (foil) structures layered with mixtures of activated carbon and suitable catalyst and fillers which are pore-formers (e.g. bicarbonates) or repellent binders (e.g. PTFE or PE.). In one embodiment, a CARBON/PTFE/NAFION mix is used to produce the anodes of the DMFC, whereby the carrier is stainless steel wool.

What is claimed is:

1. An electrochemical fuel cell comprising an inlet for a fuel, an inlet for an oxidant, an anode in contact with said fuel, a cathode in contact with said oxidant, and an electrolyte, said anode and cathode being separated and electrically connected and having opposing surfaces, said electrolyte being provided in a stream flowing between said anode and said cathode.

2. The fuel cell of claim 1 further comprising a medium located between said anode and said cathode through which said electrolyte flows.

3. The fuel cell of claim 2 wherein said medium comprises a porous material.

4. The fuel cell of claim 3 wherein said medium comprises a porous carbon material.

5. The fuel cell of claim 3 wherein said medium comprises a screen mesh material.

6. The fuel cell of claim 1 further comprising a channel located between said anode and said cathode through which said electrolyte flows.

7. The fuel cell of claim 6 wherein said channel includes more than one passage for said electrolyte.

8. The fuel cell of claim 1 wherein said anode and said cathode are formed from a porous material.

9. The fuel cell of claim 1 wherein said anode and cathode include, on said opposing sides thereof, a catalyst layer for catalyzing the electrochemical reactions of the cell.

10. The fuel cell of claim 9 wherein said catalyst layer is composed of a material chosen from the group consisting of: platinum, ruthenium, a platinum and ruthenium composite, carbon black, noble metals or combinations thereof.

11. The fuel cell of claim 1 wherein said anode and cathode are separated by a proton exchange membrane.

12. The fuel cell of claim 11 wherein said membrane is provided on a surface of said anode opposing said cathode.

13. The fuel cell of claim 12 wherein said anode includes a catalyst layer on said surface opposing said cathode and wherein said catalyst layer is positioned between said anode surface and said membrane.

14. The fuel cell of claim 11 wherein said membrane is provided on a surface of said cathode opposing said anode.

15. The fuel cell of claim 13 wherein said cathode includes a catalyst layer on said surface opposing said anode and wherein said catalyst layer is positioned between said cathode surface and said membrane.

16. The fuel cell of claim 1 wherein said electrolyte has a pH that is lower than 7.

17. The fuel cell of claim 8 wherein said anode is formed from a porous carbon base including fibre graphite.

18. The fuel cell of claim 8 wherein said anode is formed from a gold plated screen.

19. The fuel cell of claim 1 wherein said fuel is in a liquid or vapour state.

20. The fuel cell of claim 19 wherein said fuel comprises a lower alcohol.

21. The fuel cell of claim 20 wherein said fuel comprises methanol.

22. The fuel cell of claim 1 wherein said oxidant is oxygen or hydrogen peroxide.

23. The fuel cell of claim 1 further including a recycle means for recycling said electrolyte flowing out of said cell.

24. The fuel cell of claim 23 further including a means of recycling unreacted fuel from said electrolyte.

25. An electrochemical fuel cell comprising:
an inlet for a fuel;
an inlet for an oxidant;
an anode in contact with said fuel;
a cathode in contact with said oxidant;
an electrolyte;
said anode and cathode being separated by a proton exchange membrane and electrically connected and having opposing surfaces;
said anode and cathode including a respective reduction or oxidation catalyst on each of said opposing surfaces;
said electrolyte being provided in a stream flowing between said anode and said cathode; and,
a porous medium located between said anode and said cathode through which said electrolyte flows.

26. An electrochemical fuel cell comprising:
an inlet for a fuel;
an inlet for an oxidant;
an anode in contact with said fuel;
a cathode in contact with said oxidant;
an electrolyte;
said anode and cathode being separated by a proton exchange membrane and electrically connected and having opposing surfaces;
said anode and cathode including a respective reduction or oxidation catalyst on each of said opposing surfaces;
said electrolyte being provided in a stream flowing between said anode and said cathode; and,
a channel located between said anode and said cathode through which said electrolyte flows.

27. The fuel cell of claim 25 wherein said fuel is methanol.

28. The fuel cell of claim 26 wherein said fuel is methanol.

29. A method of electrochemically generating electricity by catalytic oxidation of fuel in a fuel cell, said fuel cell comprising an inlet for said fuel, an inlet for an oxidant, an anode in contact with said fuel, a cathode in contact with said oxidant, and an electrolyte, said anode and cathode being separated and electrically connected and having opposing surfaces, the method comprising:
providing said fuel and said oxidant to said fuel cell;
flowing an electrolyte between said anode and said cathode to provide electrical conduction for electrons and protons generated by said catalytic oxidation reaction and for flushing unreacted fuel and reaction byproducts from said cell.

30. The method of claim 29 wherein said electrolyte is recycled and re-used in said fuel cell.

31. The method of claim 30 wherein said unreacted fuel is recycled and re-introduced into said fuel cell.

32. The method of claim 29 wherein said fuel is methanol.

33. An electrochemical fuel cell comprising an inlet for a fuel, an inlet for an oxidant, an anode in contact with said fuel, a cathode in contact with said oxidant, and an electrolyte, said anode and cathode being separated and electrically connected and having opposing surfaces, and a purging means for removing any unreacted fuel from said fuel cell.

34. The fuel cell of claim 33 wherein said purging means comprises a flowing stream of said electrolyte.

35. The fuel cell of claim 34 further comprising a medium located between said anode and said cathode through which said electrolyte flows.

36. The fuel cell of claim 35 wherein said medium comprises a porous material.

37. The fuel cell of claim 36 wherein said medium comprises a porous carbon material.

38. The fuel cell of claim 36 wherein said medium comprises a screen mesh material.

39. The fuel cell of claim 34 further comprising a channel located between said anode and said cathode through which said electrolyte flows.

40. The fuel cell of claim 39 wherein said channel includes more than one passage for said electrolyte.

41. A fuel cell system for the electrochemical production of electricity from liquid and gaseous fuels on the anodic side and oxygen and air on the cathodic side, whereby the electrode reactions are happening in catalyst regions (interfaces) contained in porous electrodes and the reaction products are continuously removed in circulating gas streams which also provide new gas supply and in a circulating electrolyte which serves also as a heat managing liquid stream, thereby characterized, that the speed of electrolyte circulation determines the build-up of the fuel or reactant cross-over gradient in the cell and the removed methanol is reclaimed in a distillation loop.

42. Fuel Cell System according to claim 41, whereby separators or matrix may be attached to the electrodes to reduce the methanol outflow (at the anode) or minimize the reaction of the methanol on the air-cathode.

43. Matrix or separators according to claim 42, where one of the separators (on the anode) can be of the PE-Membrane type.

44. The matrix or separator barriers according to claim 42 may be chosen from microporous materials like asbestos.

45. In the system according to claim 41, the circulating electrolyte is a good conductive salt solution selected from the group of battery electrolytes with a pH of neutral to low acidic values. Examples: KSCN or NH₄SCN, acidified K₂SO₄, or selected strong organic acids (Superacids).

46. Fuel Cell System according to claim 41, whereby the temperature of the cell must be high enough to allow a methanol distillation recovery loop) (over 70 deg.C.)

47. The fuel feed can be as an aqueous solution of methanol or is methanol vapor.

48. The fuel feed according to claim 47 can be such that the concentration of the methanol (% in water or methanol gas vapor pressure) can be increased to give a higher anode voltage simultaneous with the adjustment of the methanol barriers and the speed of electrolyte circulation which reduce the crossover which will then tend to increase.

49. DMFC System according to claim 41, whereby the electrodes can be porous all-carbon electrodes (the baked carbon type) in tubular or plate shape, carrying the proper catalysts for the anode and cathode reactions.

50. DMFC System according to claim 41 where the electrodes can be of the type used for PAFC systems, sprayed or layered PTFE bonded porous carbon layers on a woven carbon (graphite) sheet or carbon fleece or carbon fiber carrier

51. Electrodes according to claim 50 where the electrodes can be stainless steel screen supported plate (foil) structures layered with mixtures of activated carbon and suitable catalyst and fillers which are pore-formers (e.g. bicarbonates) or repellent binders (e.g. PTFE or PE.)

52. Electrodes according to claim 51 whereby a CARBON/PTFE/NAFION mix is used to produce the anodes of the DMFC, whereby the carrier is stainless steel wool.
